(19) United States
(12) Patent Application Publication
(10) Pub. No.: US 2016/0380428 A1
(43) Pub. Date: Dec. 29, 2016

(54) VOLTAGE LIMITER

(71) Applicant: GENERAL ELECTRIC TECHNOLOGY GMBH, Baden (CH)

(72) Inventors: Carl David BARKER, Staffordshire (GB); Andre Paulo CANELHAS, Stafford (GB); Andrzej ADAMCZYK, Staffordshire (GB)

(73) Assignee: General Electric Technology GmbH, Baden (CH)

(21) Appl. No.: 14/902,532

(22) PCT Filed: Jul. 10, 2014
(86) PCT No.: PCT/EP2014/064871

§ 371 Date: Dec. 31, 2015

(30) Foreign Application Priority Data
Jul. 19, 2013 (EP) 13275169.4

(51) Int. Cl. H02H 9/04; H02J 1/06

(52) U.S. Cl. CPC H02H 9/045; H02J 1/06

(57) ABSTRACT

A voltage limiter includes first and second DC terminals connectable to a DC power transmission medium and ground, respectively. The voltage limiter further includes: (1) a current transmission path including two portions connected in series between the terminals and each including a non-linear resistive element; (2) a current bypass limb connected in parallel with the second portion and including at least one switching element; and (3) a control unit configured to control switching of the or each switching element to selectively switch the current bypass limb, during a fault condition, from a first mode to a second mode. In the first mode, current flows through the current bypass limb and bypasses the second current transmission path portion. In the second mode, current between the DC terminals is inhibited from flowing through the current bypass limb and thereby permits the current to flow through the second portion.

The invention relates to a voltage limiter.

In power transmission networks alternating current (AC) power is converted to direct current (DC) power for transmission via overhead lines and/or under-sea cables. This conversion removes the need to compensate for the AC capacitive load effects imposed by the power transmission medium, i.e. the transmission line or cable, and reduces the cost per kilometre of the lines and/or cables, and thus becomes cost-effective when power needs to be transmitted over a long distance.

According to an aspect of the invention, there is provided a voltage limiter, for limiting a voltage of a DC power transmission medium, comprising:
first and second DC terminals, the first DC terminal being operatively connectable to the DC power transmission medium, the second DC terminal being operatively connectable to ground;
a current transmission path extending between the first and second DC terminals and including first and second current transmission path portions, the first and second current transmission path portions being connected in series between the first and second DC terminals, the first current transmission path portion including a first non-linear resistive element, the second current transmission path portion including a second non-linear resistive element;
a current bypass limb connected in parallel with the second current transmission path portion, the current bypass limb including at least one switching element; and
a control unit configured to control switching of the or each switching element of the current bypass limb to selectively switch the current bypass limb, during a fault condition of the DC power transmission medium, from a first mode to a second mode,
wherein the current bypass limb in the first mode permits a current flowing between the first and second DC terminals to flow through the current bypass limb and thereby bypass the second current transmission path portion; and the current bypass limb in the second mode inhibits a current flowing between the first and second DC terminals from flowing through the current bypass limb and thereby permits the current flowing between the first and second DC terminals to flow through the second current transmission path portion.

A DC power transmission medium may be any medium that is capable of transmitting electrical power between two or more electrical elements. Such a medium may be, but is not limited to, a submarine DC power transmission cable, an overhead DC power transmission line or cable and an underground DC power transmission cable. Such an electrical element may be, but is not limited to, a DC power source, a load, a DC terminal of a DC power grid, or a DC electrical network.

During normal operation of the DC power transmission medium, the voltage of the DC power transmission stays at a normal operating voltage (or within a normal operating voltage range). The insulation rating of the DC power transmission medium and any further equipment connected thereto is coordinated with the normal operating voltage (or voltage range) or any prolonged overvoltage conditions, whichever is the more onerous.

The connection of the voltage limiter between the DC power transmission medium and ground means that the voltage across the voltage limiter corresponds to the voltage of the DC power transmission medium, and so the voltage across the voltage limiter during normal operation of the DC power transmission medium corresponds to the normal operating voltage (or voltage range) of the DC power transmission medium.

The protective level of the first non-linear resistive element is set so that the first non-linear resistive element presents a high impedance to a current flowing between the DC power transmission medium and ground via the voltage limiter when the voltage limiter experiences a voltage that corresponds to the normal operating voltage (or voltage range) of the DC power transmission medium. Meanwhile the current bypass limb is in the first mode so that a current flowing between the DC power transmission medium and ground via the voltage limiter does not flow through the second non-linear resistive element. Configuring the voltage limiter in this manner minimises the effect of current flowing through the voltage limiter has on the normal operation of the DC power transmission medium.

The DC power transmission medium may be subjected to a fault condition that results in the DC power transmission medium experiencing a rise in voltage above its normal operating voltage (or voltage range). The fault condition may arise as a result of a fault in the DC power transmission medium (e.g. a lightning or switching impulse applied to the DC power transmission medium) or, when the DC power transmission medium is one of a pair of DC power transmission media connected to a power converter, as a result of the other DC power transmission medium being short-circuited to ground by a pole-to-ground fault.

Since the connection of the voltage limiter between the DC power transmission medium and ground means that the voltage across the voltage limiter corresponds to the voltage of the DC power transmission medium, the voltage limiter experiences a corresponding rise in voltage when the DC power transmission medium experiences a rise in voltage above its normal operating voltage (or voltage range).

The protective level of the first non-linear resistive element is set so that the first non-linear resistive element presents a low impedance to a current flowing between the DC power transmission medium and ground via the voltage limiter when the voltage limiter experiences a corresponding rise in voltage caused by the DC power transmission medium experiencing a rise in voltage above its normal operating voltage (or voltage range). This enables the voltage limiter to conduct a higher level of current between the DC power transmission medium and ground in order to limit the voltage of the DC power transmission medium when the DC power transmission medium is subjected to the fault condition, thus minimising the stress on the insulation of the DC power transmission medium.

The ability of the voltage limiter to limit the level of voltage experienced by the DC power transmission medium subjected to the fault condition allows the DC power transmission medium to accommodate a rise in voltage above its normal operating voltage (or voltage range) with minimal need for there to be an excessive increase in insulation rating of the DC power transmission medium and any further equipment connected thereto or the need to in use temporarily disconnect the DC power transmission medium from an associated power transmission network (which would result in a total cessation of power transmission through the DC power transmission medium and any further elements of the associated power transmission network connected thereto).

When the DC power transmission medium is subjected to the fault condition, the flow of the current through the first non-linear resistive element for a prolonged period could result in thermal runaway in the first non-linear resistive element.

Thermal runaway in a non-linear resistive element occurs as a result of a continuous cycle of:
a temperature increase in the non-linear resistive element resulting in a reduction in impedance of the non-linear resistive element;
the reduction in impedance of the non-linear resistive element resulting in an increase in current flowing through the non-linear resistive element;
the increase in current flowing through the non-linear resistive element resulting in a temperature increase in the non-linear resistive element, at which point the cycle repeats itself.

Due to the amount of energy passing through the first non-linear resistive element and the limited mass of the first non-linear resistive element, thermal runaway in the first non-linear resistive element could result in destruction of the first non-linear resistive element.

To prevent thermal runaway in the first non-linear resistive element, the current bypass limb may be switched to the second mode so the current flowing between the DC power transmission medium and ground via the voltage limiter flows through both of the first and second current transmission path portions (and therefore both of the first and second non-linear resistive elements).

Switching the current bypass limb to the second mode increases the overall protective level of the voltage limiter and thereby reduces the level of current flowing through the voltage limiter. Such reduction of the level of current flowing through the first resistive non-linear resistive element can be used to prevent thermal runaway in the first non-linear resistive element caused by the current flowing through the first non-linear resistive element for a prolonged period.

After the fault causing the fault condition of the DC power transmission medium has been cleared, the current bypass limb can then be switched from the second mode to the first mode so as to return the protective level of the voltage limiter to that of the first non-linear resistive element.

The inclusion of the second current transmission path portion and current bypass limb in the voltage limiter therefore results in a voltage limiter that is not only capable of providing a limiting of the voltage of the DC power transmission medium when the DC power transmission medium is subjected to a fault condition, but also capable of selectively increasing the protective level of the voltage limiter in order to reduce the level of current flowing through the voltage limiter for a given overvoltage condition and thereby prolong the period for which this overvoltage condition can persist.

In contrast, in a conventional voltage limiter that omits the second current transmission path portion and current bypass limb, the first non-linear resistive element would either have a protective level that is too low to prevent thermal runaway from occurring, or require an increase in its protective level to reduce the risk of thermal runaway. Increasing the protective level of the first non-linear resistive element would require a corresponding increase in the insulation rating of the DC power transmission medium and any further equipment connected thereto in order for the DC power transmission medium to be able to accommodate a rise in voltage above its normal operating voltage (or voltage range).

This not only increases the cost of the DC power transmission medium and any further equipment connected thereto, but also reduces design flexibility when it comes to choosing the type of DC transmission power medium that can be used in a particular power application.

The type of non-linear resistive element used in the voltage limiter may vary. For example, each non-linear resistive element may be a surge arrester.

Preferably the first current transmission path portion is fixed between the first and second DC terminals so that a current flowing between the first and second DC terminals always flows through the first non-linear resistive element.

In embodiments of the invention, the voltage limiter may further include a capacitive limb connected in parallel with the second current transmission path portion. The capacitive limb may include at least one capacitive element.

The capacitive limb presents a low impedance to a current flowing between the DC power transmission medium and ground via the voltage limiter while the current bypass limb is in the first mode and when the or each switching element of the current bypass limb is initially opened to switch the current bypass limb from the first mode to the second mode.

Switching the current bypass limb from the first mode to the second mode causes a rapid build-up of voltage in the or each capacitive element, thereby increasing the voltage across the second current transmission path portion and causing the second non-linear resistive element to start to conduct.

The provision of the capacitive limb in the voltage limiter therefore provides controlled commutation of current from the current bypass limb to the second current transmission path portion.

In embodiments of the invention employing the use of a capacitive limb, the current bypass limb may further include an inductive element. The or each inductive element may combine with the or each capacitive element of the capacitive limb to form a resonant circuit when the current bypass limb is in the first mode. Thus, when the DC power transmission medium experiences a rise in voltage, the resonant circuit formed from the combination of the or each inductive element and the or each capacitive element is capable of forcing a current zero in the or each switching element of the current bypass limb, thus enabling soft-switching of the or each switching element of the current bypass limb.

The configuration of the or each switching element in the current bypass limb may vary depending on the switching requirements (e.g. switching speed) and power requirements (e.g. voltage and current ratings) of the voltage limiter.

At least one switching element of the current bypass limb may be a semiconductor device. The semiconductor device may be a self-commutated semiconductor device which may be, but is not limited to, an insulated gate bipolar transistor, a gate turn-off thyristor, a field effect transistor, an injection enhanced gate transistor, or an integrated gate commutated thyristor.

At least one switching element of the current bypass limb may be a circuit interruption device, e.g. an AC circuit interruption device, a mechanical circuit breaker. The provision of a circuit interruption device in the current bypass limb provides the current bypass limb with a high voltage withstand capability when the current bypass limb is in the second mode.

The number of switching elements in the current bypass limb may vary depending on the required voltage and current ratings of the current bypass limb. For example, the current bypass limb may include a plurality of series-connected switching elements and/or parallel-connected switching elements.

In embodiments of the invention, the current bypass limb may include a circuit interruption device connected in series with a switching block. The switching block may include at least one switching element. The voltage limiter may further include a control unit configured to control switching of the circuit interruption device and switching block, wherein the control unit is configured to selectively switch the switching block to switch the current bypass limb from the first mode to the second mode before opening the circuit interruption device.

In such an arrangement of the current bypass limb, the switching block may be configured to render the current bypass limb capable of fast switching (e.g. through use of one or more semiconductor devices in the switching block), and the circuit interruption device may be configured to provide the current bypass limb with a high voltage withstand capability (e.g. through use of a mechanical circuit breaker as the circuit interruption device). The inclusion of the series-connected circuit interruption device and switching block in the current bypass limb therefore enables configuration of the current bypass limb to have a combination of fast switching and high voltage withstand capabilities.

In embodiments of the invention employing the use of the switching block, at least one switching element of the switching block may be a semiconductor device.

In further embodiments of the invention employing the use of the switching block, the switching block may include a plurality of series-connected switching elements and/or parallel-connected switching elements.

The control unit may be configured to switch the current bypass limb from the first mode to the second mode when a fault condition of the DC power transmission medium is still present after a first predefined period has lapsed, the first predefined period corresponding to a duration expected of the fault condition of the DC power transmission medium.

The first predefined period may correspond to a duration of a lightning or switching impulse applied to the DC power transmission medium. This means that, during the duration expected of a lightning or switching impulse applied to the DC power transmission medium, the current flowing between the DC power transmission medium and ground flows through the first non-linear resistive element but bypasses the second current transmission path portion (and therefore bypasses the second non-linear resistive element).

When the first predefined period lapses indicating that the fault condition of the DC power transmission medium is still present, the control unit switches the current bypass limb from the first mode to the second mode so that the current flowing between the DC power transmission medium and ground flows through both of the first and second non-linear resistive elements, so as to prevent thermal runaway in the first non-linear resistive element caused by the current flowing through the first non-linear resistive element for a prolonged period.

The control unit may be configured to measure a voltage of the DC power transmission medium, wherein the control unit is configured to switch the current bypass limb from the first mode to the second mode when the control unit measures that a predefined voltage threshold of the DC power transmission medium has been exceeded for a second predefined period, the predefined voltage threshold corresponding to a fault condition of the DC power transmission medium.

The predefined voltage threshold may correspond to a fault condition in the DC power transmission medium arising from a lightning or switching impulse applied to the DC power transmission medium. This means that, when the DC power transmission medium experiences a voltage that corresponds to a lightning or switching impulse applied to the DC power transmission medium but is at or below the predefined voltage threshold, the current flowing between the DC power transmission medium and ground flows through the first non-linear resistive element but bypasses the second current transmission path portion (and therefore bypasses the second non-linear resistive element).

When the control unit measures that a predefined voltage threshold of the DC power transmission medium has been exceeded for the second predefined period, the control unit switches the current bypass limb from the first mode to the second mode so that the current flowing between the DC power transmission medium and ground flows through both of the first and second non-linear resistive elements, so as to prevent thermal runaway in the first non-linear resistive element caused by the current flowing through the first non-linear resistive element for a prolonged period.

Configuring the control unit in this manner allows the current bypass limb to be automatically switched from the first mode to the second mode in response to the first predefined period lapsing or the predefined voltage threshold being exceeded for the second predefined period, thus resulting in a more responsive and reliable voltage limiter.

Preferred embodiments of the invention will now be described, by way of non-limiting examples only, with reference to the accompanying drawings in which:

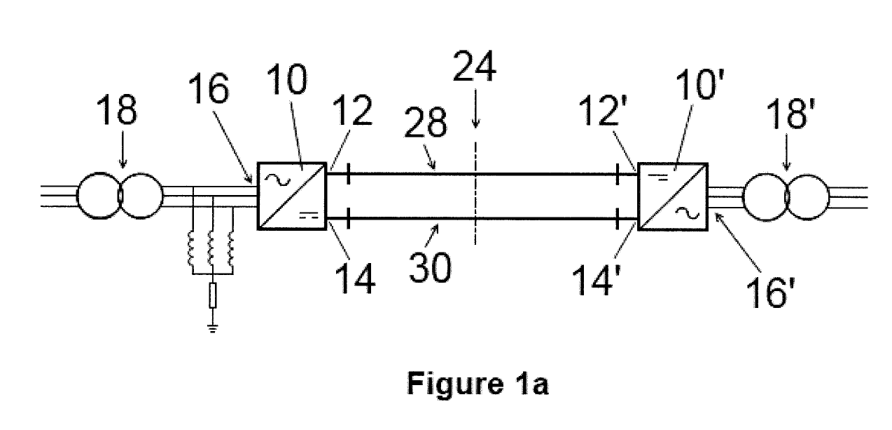

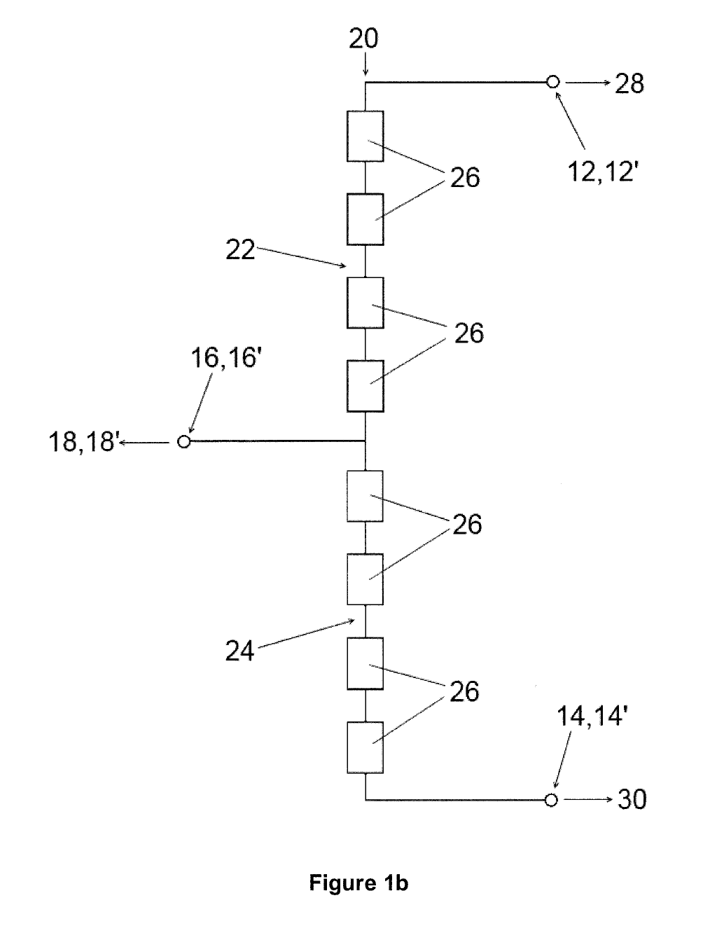

FIG. 1a shows, in schematic form, a power transmission network;

FIG. 1b shows, in schematic form, a power converter of the power transmission network shown in FIG. 1a;

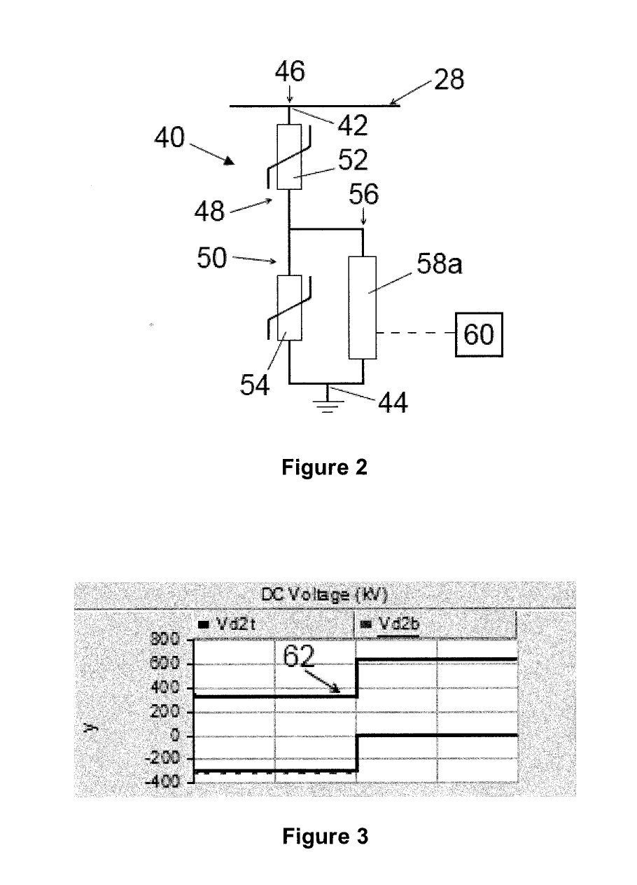

FIG. 2 shows, in schematic form, a voltage limiter according to a first embodiment of the invention;

FIG. 3 illustrates, in graph form, the voltage experienced by the first DC power transmission medium shown in FIG. 1a during normal operation and a fault condition of the first DC power transmission medium;

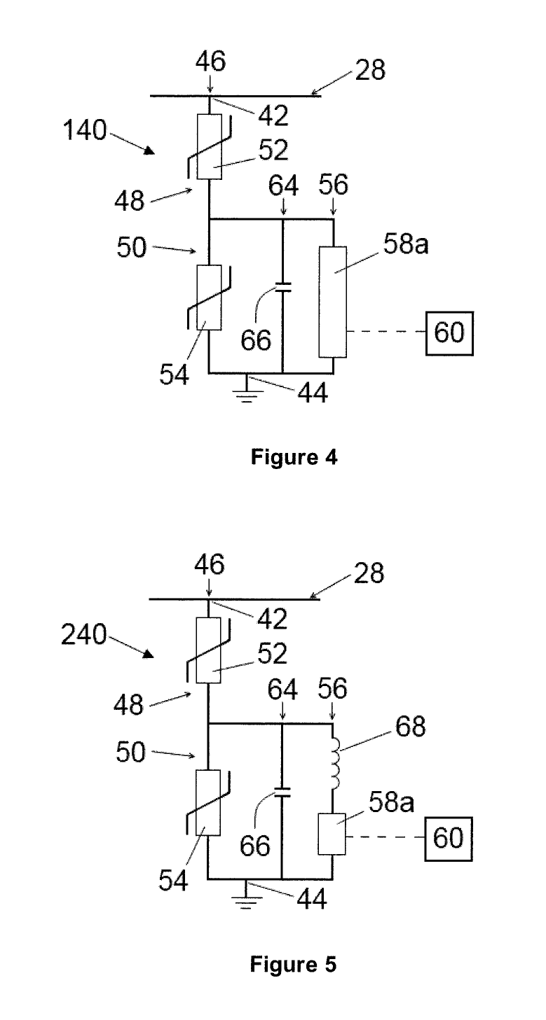

FIG. 4 shows, in schematic form, a voltage limiter according to a second embodiment of the invention;

FIG. 5 shows, in schematic form, a voltage limiter according to a third embodiment of the invention; and

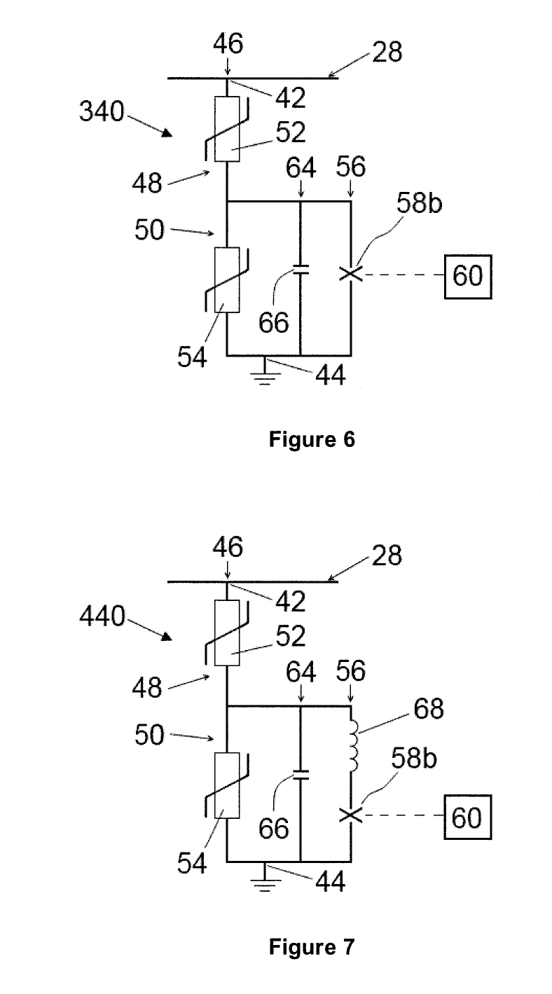

FIG. 6 shows, in schematic form, a voltage limiter according to a fourth embodiment of the invention;

FIG. 7 shows, in schematic form, a voltage limiter according to a fifth embodiment of the invention;

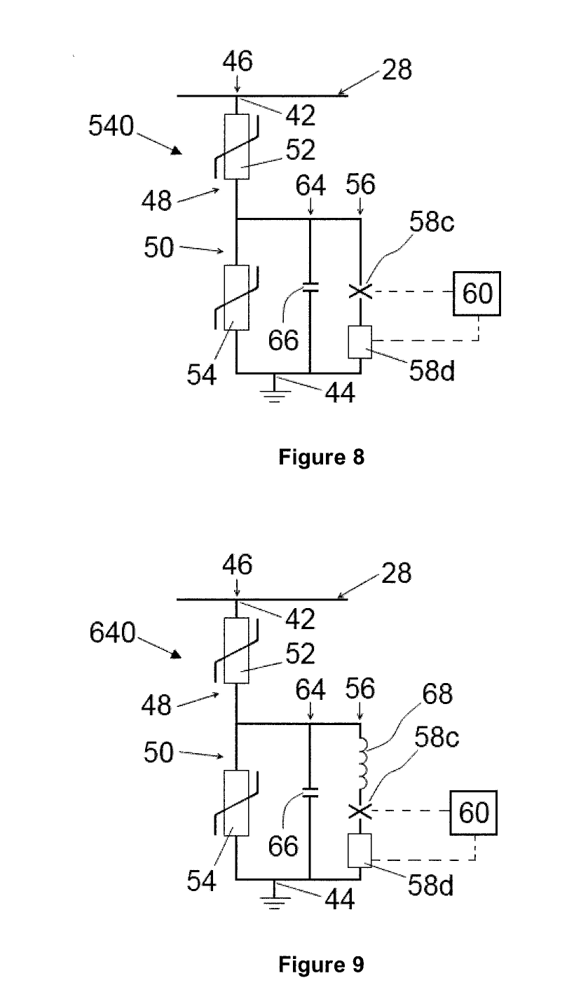

FIG. 8 shows, in schematic form, a voltage limiter according to a sixth embodiment of the invention; and

FIG. 9 shows, in schematic form, a voltage limiter according to a seventh embodiment of the invention.

A power transmission network is shown in FIG. 1a, and includes first and second power converters 10,10′.

Each power converter 10,10′ includes a first DC terminal 12,12′ and a second DC terminal 14,14′.

In addition the power converter 10,10′ shown in FIG. 1a includes a plurality of AC terminals 16,16′, each of which in use is connected to a respective phase of a multi-phase AC network 18,18′. More particularly, each power converter 10,10′ shown in FIG. 1a defines an AC/DC voltage source converter which includes a plurality of converter limbs, each of which is arranged as shown in FIG. 1b.

Each converter limb 20 extends between the first and second DC terminals 12,12′,14,14′ and includes a first limb portion 22 that extends between the first DC terminal 12,12′ and the AC terminal 16,16′, and a second limb portion 24 which extends between the second DC terminal 14,14′ and the AC terminal 16,16′.

Each limb portion 22,24 includes a plurality of series-connected modules 26. In the specific embodiment shown, each module 26 includes a pair of switching elements that are connected in parallel with an energy storage device in a half-bridge arrangement to define a 2-quadrant unipolar module that can provide a zero or positive voltage source and can conduct current in two directions.

It will be appreciated that the topology of each power converter 10,10′ is merely chosen to help illustrate the operation of the invention, and that each power converter 10,10′ may be replaced by another power converter with a different topology.

The first DC terminals 12,12′ of each power converter 10,10′ are operatively interconnected by a first DC power transmission cable 28 and the second DC terminals 14, 14′ of each power converter 10,10′ are operatively interconnected by a second DC power transmission cable 30. Each of the first and second DC power transmission cables 28,30 form part of a DC power transmission network 32.

A first voltage limiter 40 according to a first embodiment of the invention is shown in FIG. 2.

The first voltage limiter 40 comprises first and second DC terminals 42,44 and a current transmission path 46.

In use, the first DC terminal 42 of the first voltage limiter 40 is connected to the first DC power transmission cable 28, while the second DC terminal 44 of the first voltage limiter 40 is connected to ground.

The current transmission path 46 extends between the first and second DC terminals 42,44 of the first voltage limiter 40 and includes first and second current transmission path portions 48,50. More specifically, the first and second current transmission path portions 48,50 are connected in series between the first and second DC terminals 42,44 of the first voltage limiter 40. The first current transmission path portion 48 includes a first non-linear resistive element 52. The second current transmission path portion 50 includes a second non-linear resistive element 54.

Each non-linear resistive element 52,54 is a surge arrester. It is envisaged that, in other embodiments of the invention, each surge arrester may be replaced by another type of non-linear resistive element.

In the embodiment shown, the first current transmission path portion 48 is fixed between the first and second DC terminals 42,44 of the first voltage limiter 40 so that a current flowing between the first and second DC terminals 42,44 of the first voltage limiter 40 always flows through the first non-linear resistive element 52.

The first voltage limiter 40 further includes a current bypass limb 56 that is connected in parallel with the second current transmission path portion 50. The current bypass limb 56 includes a single switching element 58a in the form of an insulated gate bipolar transistor (IGBT).

It is envisaged that, in other embodiments of the invention, the single switching element of the current bypass limb may be replaced by a plurality of series-connected switching elements and/or parallel-connected switching elements.

The first voltage limiter 40 further includes a control unit 60 configured to control switching of the switching element 58a in the current bypass limb 56. More specifically, the control unit 60 is configured to control switching of the switching element 58a of the current bypass limb 56 to selectively switch the current bypass limb 56 between a first mode and a second mode.

Switching the current bypass limb 56 to the first mode permits a current flowing between the first and second DC terminals 42,44 of the first voltage limiter 40 to flow through the current bypass limb 56 and thereby bypass the second current transmission path portion 50 (and therefore bypass the second non-linear resistive element 54).

Switching the current bypass limb 56 to the second mode inhibits a current flowing between the first and second DC terminals 42,44 of the first voltage limiter 40 from flowing through the current bypass limb 56 and thereby permits the current flowing between the first and second DC terminals 42,44 of the first voltage limiter 40 to flow through the second current transmission path portion 50 (and therefore the second non-linear resistive element 54).

In use, during normal operation of the power transmission network, the power converters 10,10′ are operated to generate a normal operating voltage difference, e.g. of approximately 640 kV, between the first and second DC terminals 12,12′,14,14′ of each respective power converter 10,10′.

The power converters 10,10′ are operated to generate such a normal operating voltage difference by setting the first DC terminals 12,12′ of the power converters to operate at a first normal operating voltage 62, e.g. +320 kV, and the second DC terminals 14,14′ of the power converters to operate at a second normal operating voltage, e.g. −320 kV, as shown in FIG. 3. More particularly the power converters 10,10′ are operated to control each module 26 in each first limb portion 22 to selectively provide a voltage source so as to generate +320 kV at the first DC terminals 12,12′ of the power converters 10,10′ and to control each module 26 in each second limb portion 24 so as to generate −320 kV at the second DC terminals 14,14′ of the power converters 10,10′.

Under such conditions, although the normal operating voltage difference between the first and second DC terminals 12,12′,14,14′ of the power converters 10,10′ is 640 kV, the voltage potential with respect to ground at each of the first and second DC terminals 12,12′,14,14′ of the power converters 10,10′ is only 320 kV, and so each of the respective DC power transmission cables 28,30 experiences a normal operating voltage of only 320 kV. Thus the insulation rating of each DC power transmission cable 28,30 is coordinated with the respective normal operating voltage of 320 kV.

In other embodiments of the invention (not shown) the power converters may be operated to set the first and second DC terminals of the power converters to operate at respective first and second normal operating voltages that are different to those set out above, and more particularly are not necessarily arranged symmetrically either side of ground, i.e. zero volts.

The connection of the first voltage limiter 40 between the first DC power transmission cable 28 and ground means that the voltage across the first voltage limiter 40 corresponds to the voltage of the first DC power transmission cable 28, and so the voltage across the first voltage limiter 40 during normal operation of the power transmission network (and therefore the first DC power transmission cable 28) corresponds to the first normal operating voltage of the first DC power transmission cable 28.

The protective level of the first non-linear resistive element 52 is set so that the first non-linear resistive element 52 presents a high impedance to a current flowing between the first DC power transmission cable 28 and ground via the first voltage limiter 40 when the first voltage limiter 40 experiences a voltage that corresponds to the first normal operating voltage of the first DC power transmission cable 28. Meanwhile the current bypass limb 56 is in the first mode so that a current flowing between the first DC power transmission cable 28 and ground via the first voltage limiter 40 does not flow through the second non-linear resistive element 54. Configuring the first voltage limiter 40 in this manner minimises the effect of current flowing through the first voltage limiter 40 has on the normal operation of the first DC power transmission cable 28 (and therefore the power transmission network).

The first DC power transmission cable 28 may be subjected to a fault condition that results in the first DC power transmission cable 28 experiencing a rise in voltage above its first normal operating voltage. The fault condition may arise as a result of a fault in the first DC power transmission cable 28 (e.g. a lightning or switching impulse applied to the first DC power transmission cable 28) or as a result of the second DC power transmission cable 30 being short-circuited to ground by a pole-to-ground fault and thereby causing the voltage 62 of the first DC power transmission cable 28 to rise to 640 kV, as shown in FIG. 3.

Since the connection of the first voltage limiter 40 between the first DC power transmission cable 28 and ground means that the voltage across the first voltage limiter 40 corresponds to the voltage of the first DC power transmission cable 28, the first voltage limiter 40 experiences a corresponding rise in voltage when the first DC power transmission cable 28 experiences a rise in voltage above its first normal operating voltage.

The protective level of the first non-linear resistive element 52 is set so that the first non-linear resistive element 52 presents a low impedance to a current flowing between the first DC power transmission cable 28 and ground via the first voltage limiter 40 when the first voltage limiter 40 experiences a corresponding rise in voltage caused by the first DC power transmission cable 28 experiencing a rise in voltage above its first normal operating voltage. This enables the first voltage limiter 40 to conduct a higher level of current between the first DC power transmission cable 28 and ground in order to limit the voltage of the first DC power transmission cable 28 when the first DC power transmission cable 28 is subjected to the fault condition, thus minimising the stress on the insulation of the first DC power transmission cable 28.

When the first DC power transmission cable 28 is subjected to the fault condition, the flow of the current through the first non-linear resistive element 52 for a prolonged period could result in thermal runaway in the first non-linear resistive element 52.

To prevent thermal runaway in the first non-linear resistive element 52, the control unit 60 switches the current bypass limb 56 to the second mode so the current flowing between the first DC power transmission cable 28 and ground via the first voltage limiter 40 flows through both of the first and second current transmission path portions 48,50 (and therefore both of the first and second non-linear resistive elements 52,54).

Switching the current bypass limb 56 to the second mode increases the overall protective level of the first voltage limiter 40 and thereby reduces the level of current flowing through the first voltage limiter 40. Such reduction of the level of current flowing through the first non-linear resistive element 52 can be used to prevent thermal runaway in the first non-linear resistive element 52 caused by the current flowing through the first non-linear resistive element 52 for a prolonged period.

After the fault causing the fault condition of the first DC power transmission cable 28 has been cleared, the control unit 60 switches the current bypass limb 56 from the second mode to the first mode so as to return the protective level of the first voltage limiter 40 to that of the first non-linear resistive element 52.

The ability of the first voltage limiter 40 to limit the level of voltage experienced by the first DC power transmission cable 28 subjected to the fault condition allows the first DC power transmission cable 28 to accommodate a rise in voltage above its first normal operating voltage with minimal need for there to be an excessive increase in insulation rating of the first DC power transmission cable 28 and any further equipment connected thereto or the need to in use temporarily disconnect the first DC power transmission cable 28 from the power transmission network (which would result in a total cessation of power transmission through the first DC power transmission cable 28 and any further elements of the associated power transmission network connected thereto).

The inclusion of the second current transmission path portion 50 and current bypass limb 56 in the first voltage limiter 40 therefore results in a first voltage limiter 40 that is not only capable of providing a limiting of the voltage of the first DC power transmission medium when the first DC power transmission medium is subjected to a fault condition, but also capable of selectively increasing the protective level of the first voltage limiter 40 in order to reduce the level of current flowing through the first voltage limiter 40 for a given overvoltage condition and thereby prolong the period for which this overvoltage condition can persist.

In contrast, in a conventional voltage limiter that omits the second current transmission path portion and current bypass limb, the first non-linear resistive element would either have a protective level that is too low to prevent thermal runaway from occurring, or require an increase in its protective level to reduce the risk of thermal runaway. Increasing the protective level of the first non-linear resistive element would require a corresponding increase in the insulation rating of an associated DC power transmission cable and any further equipment connected thereto in order for the DC power transmission cable to be able to accommodate a rise in voltage above its normal operating voltage. This not only increases the cost of the DC power transmission cable and any further equipment connected thereto, but also reduces design flexibility when it comes to choosing the type of DC transmission power cable that can be used in a particular power application.

Optionally the control unit 60 may be configured to switch the current bypass limb 56 from the first mode to the second mode when a fault condition of the first DC power transmission cable 28 is still present after a first predefined period has lapsed, the first predefined period corresponding to a duration expected of the fault condition of the first DC power transmission cable 28.

The first predefined period may correspond to a duration of a lightning or switching impulse applied to the first DC power transmission cable 28. This means that, during the duration expected of a lightning or switching impulse applied to the first DC power transmission cable 28, the current flowing between the first DC power transmission cable 28 and ground flows through the first non-linear resistive element 52 but bypasses the second current transmission path portion 50 (and therefore bypasses the second non-linear resistive element 54).

When the first predefined period lapses indicating that the fault condition of the first DC power transmission cable 28 is still present, the control unit 60 switches the current bypass limb 56 from the first mode to the second mode so that the current flowing between the first DC power transmission cable 28 and ground flows through both of the first and second non-linear resistive elements 52,54, so as to prevent thermal runaway in the first non-linear resistive element 52 caused by the current flowing through the first non-linear resistive element 52 for a prolonged period.

Further optionally the control unit 60 may be configured to measure a voltage of the first DC power transmission cable 28, and the control unit 60 may be configured to switch the current bypass limb 56 from the first mode to the second mode when the control unit 60 measures that a predefined voltage threshold of the first DC power transmission cable 28 has been exceeded for a second predefined period, the predefined voltage threshold corresponding to a fault condition of the first DC power transmission cable 28.

The predefined voltage threshold may correspond to a fault condition in the first DC power transmission cable 28 arising from a lightning or switching impulse applied to the first DC power transmission cable 28. This means that, when the first DC power transmission cable 28 experiences a voltage that corresponds to a lightning or switching impulse applied to the first DC power transmission cable 28 but is at or below the predefined voltage threshold, the current flowing between the first DC power transmission cable 28 and ground flows through the first non-linear resistive element 52 but bypasses the second current transmission path portion 50 (and therefore bypasses the second non-linear resistive element 54).

When the control unit 60 measures that a predefined voltage threshold of the first DC power transmission cable 28 has been exceeded for the second predefined period, the control unit 60 switches the current bypass limb 56 from the first mode to the second mode so that the current flowing between the first DC power transmission cable 28 and ground flows through both of the first and second non-linear resistive elements 52,54, so as to prevent thermal runaway in the first non-linear resistive element 52 caused by the current flowing through the first non-linear resistive element 52 for a prolonged period.

Configuring the control unit 60 in this manner allows the current bypass limb 56 to be automatically switched from the first mode to the second mode in response to the first predefined period lapsing or the predefined voltage threshold being exceeded for the second predefined period, thus resulting in a more responsive and reliable first voltage limiter 40.

The configuration of the switching element 58a in the current bypass limb 56 may vary depending on the switching requirements (e.g. switching speed) and power requirements (e.g. voltage and current ratings) of the first voltage limiter 40.

In other embodiments of the invention (not shown), it is envisaged that the IGBT of the current bypass limb may be replaced by another type of switching element or another type of semiconductor device, such as a self-commutated semiconductor device. Such a self-commutated semiconductor device may be, but is not limited to, an insulated gate bipolar transistor, a gate turn-off thyristor, a field effect transistor, an injection enhanced gate transistor, or an integrated gate commutated thyristor.

The number of switching elements in the current bypass limb 56 may vary depending on the required voltage and current ratings of the current bypass limb 56. For example, the current bypass limb may include a plurality of series-connected switching elements and/or parallel-connected switching elements.

It will be appreciated that the configuration of the power transmission network shown in FIG. 1a is merely chosen to help illustrate the operation of the invention, and that the invention may be used to limit the voltage of a DC power transmission cable configured in other ways.

Furthermore each DC power transmission cable 28,30 may be replaced by any medium that is capable of transmitting electrical power between two or more electrical elements. Such a medium may be, but is not limited to, a submarine DC power transmission cable, an overhead DC power transmission line or cable and an underground DC power transmission cable. Such an electrical element may be, but is not limited to, a DC power source, a load, a DC terminal of a DC power grid, or a DC electrical network.

A second voltage limiter 140 according to a second embodiment of the invention is shown in FIG. 4. The second voltage limiter 140 of FIG. 4 is similar in structure and operation to the first voltage limiter 40 of FIG. 1, and like features share the same reference numerals.

The second voltage limiter 140 differs from the first voltage limiter 40 in that the second voltage limiter 140 further includes a capacitive limb 64 connected in parallel with the second current transmission path portion 50. The capacitive limb 64 includes a capacitor 66.

The capacitive limb 64 presents a low impedance to a current flowing between the first DC power transmission cable 28 and ground via the second voltage limiter 140 while the current bypass limb 56 is in the first mode and when the control unit 60 initially opens the switching element of the current bypass limb 56 to switch the current bypass limb 56 from the first mode to the second mode. Switching the current bypass limb 56 from the first mode to the second mode causes a rapid build-up of voltage in the capacitor 66, thereby increasing the voltage across the second current transmission path portion 50 and causing the second non-linear resistive element 54 to start to conduct.

The provision of the capacitive limb 64 in the second voltage limiter 140 therefore provides controlled commutation of current from the current bypass limb 56 to the second current transmission path portion 50.

A third voltage limiter 240 according to a third embodiment of the invention is shown in FIG. 5. The third voltage limiter 240 of FIG. 5 is similar in structure and operation to the second voltage limiter 140 of FIG. 4, and like features share the same reference numerals.

The third voltage limiter 240 differs from the second voltage limiter 140 in that the current bypass limb 56 of the third voltage limiter 240 further includes an inductor 68 connected in series with the switching element 58a.

The series connection of the inductor 68 and switching element 58a in the current bypass limb 56 means that, when the current bypass limb 56 is in the first mode, the inductive element 68 is connected in parallel with the capacitor 66 of the capacitive limb 64 to form a resonant circuit. Thus, when the first DC power transmission cable 28 experiences a rise in voltage, the resonant circuit formed from the parallel connection of the inductor 68 and capacitor 66 is capable of forcing a current zero in the switching element 58a of the current bypass limb 56, thus enabling soft-switching of the switching element 58a of the current bypass limb 56.

A fourth voltage limiter 340 according to a fourth embodiment of the invention is shown in FIG. 6. The fourth voltage limiter 340 of FIG. 6 is similar in structure and operation to the second voltage limiter 140 of FIG. 4, and like features share the same reference numerals.

The fourth voltage limiter 340 differs from the second voltage limiter 140 in that the switching element 58b of the current bypass limb 56 of the fourth voltage limiter 340 is a circuit interruption device in the form of a AC mechanical circuit breaker.

The provision of an AC mechanical circuit breaker in the current bypass limb 56 provides the current bypass limb 56 with a high voltage withstand capability when the current bypass limb 56 is in the second mode.

A fifth third voltage limiter 240 according to a fifth embodiment of the invention is shown in FIG. 7. The fifth voltage limiter 440 of FIG. 7 is similar in structure and operation to the fourth voltage limiter 340 of FIG. 6, and like features share the same reference numerals.

The fifth voltage limiter 440 differs from the fourth voltage limiter 340 in that the current bypass limb 56 of the fifth voltage limiter 440 further includes an inductor 68 connected in series with the switching element 58b.

The fifth voltage limiter 440 is similar in operation to the third voltage limiter 240 with respect to the inductor 68 and its combination with the capacitor 66 to form a resonant circuit capable of forcing a current zero in the switching element 58b of the current bypass limb 56.

A sixth voltage limiter 540 according to a sixth embodiment of the invention is shown in FIG. 8. The sixth voltage limiter 540 of FIG. 8 is similar in structure and operation to the fourth voltage limiter 340 of FIG. 6, and like features share the same reference numerals.

The sixth voltage limiter 540 differs from the fourth voltage limiter 340 in that the current bypass limb 56 of the sixth voltage limiter 540 includes a circuit interruption device 58c connected in series with a switching block 58d.

The circuit interruption device 58c is in the form of a AC mechanical circuit breaker. The use of the AC mechanical circuit breaker as the circuit interruption device 58c provides the current bypass limb 56 with a high voltage withstand capability.

The switching block 58d includes a switching element in the form of an IGBT. The use of the IGBT in the switching block 58d renders the current bypass limb 56 capable of fast switching.

In other embodiments of the invention (not shown), it is envisaged that the switching block of the current bypass limb may include a plurality of series-connected switching elements and/or parallel-connected switching elements.

The control unit 60 is configured to control switching of the circuit interruption device 58c and switching block 58d. More specifically, the control unit 60 is configured to selectively switch the switching block 58d to switch the current bypass limb 56 from the first mode to the second mode before opening the circuit interruption device 58c. This not only enables fast switching of the current bypass limb 56 from the first mode to the second mode, but also allows the current flowing through the circuit interruption device 58c to drop to a near-zero or zero value, thus enabling soft-switching of the circuit interruption device 58c. After the control unit 60 opens the circuit interruption device 58c, the current bypass limb 56 is provided with a high voltage withstand capability.

The inclusion of the series-connected circuit interruption device 58c and switching block 58d in the current bypass limb 56 therefore enables configuration of the current bypass limb 56 to have a combination of fast switching and high voltage withstand capabilities.

A seventh voltage limiter 640 according to a seventh embodiment of the invention is shown in FIG. 9. The seventh voltage limiter 640 of FIG. 9 is similar in structure and operation to the sixth voltage limiter 540 of FIG. 8, and like features share the same reference numerals.

The seventh voltage limiter 640 differs from the sixth voltage limiter 540 in that the current bypass limb 56 of the sixth voltage limiter 540 further includes an inductor 68 connected in series with the circuit interruption device 58c and switching block 58d.

The seventh voltage limiter 640 is similar in operation to each of the third and fifth voltage limiters 240,440 with respect to the inductor 68 and its combination with the capacitor 66 to form a resonant circuit capable of forcing a current zero in the switching block 58d of the current bypass limb 56.

It is envisaged that, in other embodiments of the invention (not shown), each of the third, fourth, fifth, sixth and seventh voltage limiters may omit the capacitive limb.

In other embodiments of the invention (not shown) employing the use of a capacitive limb, it is envisaged that the capacitor of the capacitive limb may be replaced by a plurality of series-connected capacitors and/or parallel-connected capacitors.

In other embodiments of the invention (not shown) employing the use of an inductor in the current bypass limb, it is envisaged that the inductor in the current bypass limb may be replaced by a plurality of series-connected inductors and/or parallel-connected inductors.

In other embodiments of the invention (not shown) employing the use of an AC mechanical circuit breaker in the current bypass limb, it is envisaged that the AC mechanical circuit breaker may be replaced by another type of circuit interruption device.

In still other embodiments of the invention (not shown) employing the use of an AC mechanical circuit breaker in the current bypass limb, it is envisaged that the AC mechanical circuit breaker of the current bypass limb may be replaced by a plurality of series-connected AC mechanical circuit breakers and/or parallel-connected AC mechanical circuit breakers.

1. A voltage limiter, for limiting a voltage of a DC power transmission medium, comprising:
first and second DC terminals, the first DC terminal being operatively connectable to the DC power transmission medium, the second DC terminal being operatively connectable to ground;
a current transmission path extending between the first and second DC terminals and including first and second current transmission path portions, the first and second current transmission path portions being connected in series between the first and second DC terminals, the first current transmission path portion including a first non-linear resistive element, the second current transmission path portion including a second non-linear resistive element;
a current bypass limb connected in parallel with the second current transmission path portion, the current bypass limb including at least one switching element; and
a control unit configured to control switching of the or each switching element of the current bypass limb to selectively switch the current bypass limb, during a fault condition of the DC power transmission medium, from a first mode to a second mode,
wherein the current bypass limb in the first mode permits a current flowing between the first and second DC terminals to flow through the current bypass limb and thereby bypass the second current transmission path portion, and the current bypass limb in the second mode inhibits a current flowing between the first and second DC terminals from flowing through the current bypass limb and thereby permits the current flowing between the first and second DC terminals to flow through the second current transmission path portion.

2. A voltage limiter according to claim 1 wherein each non-linear resistive element is a surge arrester.

3. A voltage limiter according to claim 1 wherein the first current transmission path portion is fixed between the first and second DC terminals so that a current flowing between the first and second DC terminals always flows through the first non-linear resistive element.

4. A voltage limiter according to claim 1 further including a capacitive limb connected in parallel with the second current transmission path portion, the capacitive limb including at least one capacitive element.

5. A voltage limiter according to claim 4 wherein the current bypass limb further includes at least one inductive element, the or each inductive element combining with the or each capacitive element of the capacitive limb to form a resonant circuit when the current bypass limb is in the first mode.

6. A voltage limiter according to claim 1 wherein at least one switching element of the current bypass limb is a semiconductor device.

7. A voltage limiter according to claim 1 wherein at least one switching element of the current bypass limb is a circuit interruption device.

8. A voltage limiter according to claim 1 wherein the current bypass limb includes a plurality of series-connected switching elements and/or parallel-connected switching elements.

9. A voltage limiter according to claim 1 wherein the current bypass limb includes a circuit interruption device connected in series with a switching block, the switching block including at least one switching element, the voltage limiter further including a control unit configured to control switching of the circuit interruption device and switching block, wherein the control unit is configured to selectively switch the switching block to switch the current bypass limb from the first mode to the second mode before opening the circuit interruption device.

10. A voltage limiter according to claim 9 wherein at least one switching element of the switching block is a semiconductor device.

11. A voltage limiter according to claim 9 wherein the switching block includes a plurality of series-connected switching elements and/or parallel-connected switching elements.

12. A voltage limiter according to claim 1 wherein the control unit is configured to switch the current bypass limb from the first mode to the second mode when a fault condition of the DC power transmission medium is still present after a first predefined period has lapsed, the first predefined period corresponding to a duration expected of the fault condition of the DC power transmission medium.

13. A voltage limiter according to claim 1 wherein the control unit is further configured to measure a voltage of the DC power transmission medium, wherein the control unit is configured to switch the current bypass limb from the first mode to the second mode when the control unit measures that a predefined voltage threshold of the DC power transmission medium has been exceeded for a second predefined period, the predefined voltage threshold corresponding to a fault condition of the DC power transmission medium.
